(19) United States
(12) Patent Application Publication
(10) Pub. No.: US 2025/0368262 A1
(43) Pub. Date: Dec. 4, 2025

(54) METHODS FOR TRAILER BACK-UP ASSIST UTILIZING STEER-BY-WIRE

(71) Applicant: Volvo Car Corporation, Göteborg (SE)

(72) Inventors: Chang Liu, Shanghai (CN); Jakob Magnus Agne Roempke, Täby (SE); Matthijs Klomp, Ljungskile (SE)

(21) Appl. No.: 19/298,331

(22) Filed: Aug. 13, 2025

Related U.S. Application Data
(63) Continuation-in-part of application No. 18/999,065, filed on Dec. 23, 2024.
(60) Provisional application No. 63/652,379, filed on May 28, 2024.

(51) Int. Cl. B62D 13/06

(52) U.S. Cl. CPC B62D 13/06

(57) ABSTRACT

A trailer backup assist system and method are disclosed that utilize a steer-by-wire architecture and advanced control algorithms to enable intuitive and stable trailer reversing. A hitch angle determination module measures or estimates the angular relationship between a towing vehicle and a trailer. A proportional controller computes a desired hitch angle rate based on the difference between a target and current hitch angle, and a processing unit converts this rate to a front wheel steering angle using a linearized kinematic model. The system includes a trailer length estimator that passively infers trailer geometry during motion, and optionally applies torque feedback to the steering wheel to guide the driver. Sensor fusion from inertial sensors, mechanical linkages, or vision-based systems enables flexible hitch angle estimation. Experimental results demonstrate that the system stabilizes trailer motion with reduced driver input and prevents jackknifing through adaptive control.

### CROSS REFERENCE TO RELATED APPLICATION

This application is a continuation-in-part application of U.S. patent application Ser. No. 18/999,065 filed Dec. 23, 2024, which claims the benefit of U.S. Provisional Patent Application No. 63/652,379 filed May 28, 2024, and entitled “METHODS FOR TRAILER BACK-UP ASSIST UTILIZING STEER-BY-WIRE.” These application(s) are incorporated herein by reference in entirety.

### TECHNICAL FIELD

Embodiments disclosed and claimed herein relate to utilizing a steer-by-wire system in conjunction with a closed loop-trailer reversal control system to enable a trailer back-up assist system.

### BACKGROUND

Reversing a trailer using a vehicle is an unstable process which can be challenging even for experienced drivers. The main challenge being the non-minimum-phase property of vehicle-trailer kinematics resulting from off-axle interconnections. A small disturbance or an error can cause a big offset on the trailer direction, making it less intuitive for drivers to correct and maintain the trailer direction.

### SUMMARY

The following presents a summary to provide a basic understanding of one or more embodiments of the invention. This summary is not intended to identify key or critical elements or delineate any scope of the different embodiments or any scope of the claims. Its sole purpose is to present concepts in a simplified form as a prelude to the more detailed description that is presented later. In one or more embodiments described herein, systems, computer-implemented methods, apparatus and/or computer program products are presented that facilitate remotely controlling vehicle functions and applications accessed by a remote auxiliary device that employs a private digital key to maintain privacy and consent management.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory.

In various embodiments, the computer-executable components can comprise a steer-by-wire component configured to receive steering wheel input and navigate the vehicle in reverse mode; also a hitch angle component that estimates a hitch angle of a trailer coupled to the vehicle, and estimates angular rate of the hitch through the data gathered from the hitch angle component; and a controller that controls speed of the vehicle and front wheel steering angle input to maintain the hitch angle within a stable range. Another embodiment may further comprise an artificial intelligence component that has been implicitly trained to facilitate the controller maintaining the hitch angle within the stable range along with further an artificial intelligence component that has been explicitly trained to facilitate the controller maintaining the hitch angle within the stable range.

It is to be appreciated that throughout this document where “steering wheel input” is mentioned it is possible in various embodiments to use other input devices than the steering wheel for the trailer backup task. These could include joysticks, knobs or other human machine interface (HMI) devices. It's also possible for a driver to remotely control the trailer backup process by a remote-control device. In this case the remote control device could have knob, joystick, pushbuttons, etc.). Furthermore, when hitch angle is mentioned throughout this document, it is to be appreciated that this refers to hitch or articulation angle—these terms are to be considered interchangeable in various embodiments.

Embodiments disclosed herein provide a trailer backup assist system in which a steer-by-wire component is operatively coupled to receive steering wheel input from a driver or alternative human-machine interface. A hitch angle determination module detects the instantaneous articulation angle ϕ between the vehicle and a trailer coupled thereto, such detection being achieved via inertial measurement units, mechanical transducers, or equivalent sensing modalities. A control system implements a proportional feedback controller that computes a target hitch angular rate ϕ^{⋅} as a function of the deviation between a commanded hitch angle ϕₜ and the measured hitch angle ϕ, such that ϕ^{⋅}=k(ϕₜ—ϕ), where k is a positive gain selected to ensure closed-loop stability during reverse maneuvers. To enable accurate model-based control without manual calibration, a trailer length estimation component derives the distance L₃ from the tow hitch to the trailer axle by applying a steady-state formulation of the nonlinear trailer kinematics equation to observed steering angle, vehicle speed, and hitch angle data, for example when the vehicle traverses a constant-radius path. A processing unit, which may comprise an embedded microcontroller, FPGA, or other computational platform, is configured to execute control logic that transforms the commanded ϕ^{⋅} into a corresponding front-wheel steering angle command using a locally linearized form of the trailer kinematic model, thereby enabling the steer-by-wire system to maintain the hitch angle within a stable operating range and to suppress jackknife tendencies. It is further to be appreciated that a steering wheel interface can configured to receive driver input to generate hitch or articulation angle (ϕ), based on a position of the steering wheel.

In one or more embodiments, a computer-implemented method for assisting trailer reversal using a steer-by-wire vehicle system is provided. The method includes acquiring, via a hitch angle sensor module, a real-time measurement of the articulation angle ϕ between the vehicle and a trailer coupled thereto. A desired hitch angle ϕₜ, representing a target articulation geometry, is received from a user input device such as a steering wheel, joystick, or other human-machine interface. A controller executes a proportional feedback control law of the form ϕ^{⋅}=k(ϕₜ−ϕ), where k is a positive gain value chosen to maintain system stability and responsiveness, thereby producing a target hitch angular rate ϕ^{⋅}. This target rate is mapped to a corresponding front wheel steering angle command using a linearized trailer kinematic model that incorporates vehicle speed and the effective trailer length L₃. The trailer length L₃ is estimated in real time from measured vehicle speed, hitch angle ϕ, hitch angular rate ϕ^{⋅}, and front wheel steering angle, for example by applying a steady-state formulation of the nonlinear trailer kinematics equation under conditions of constant-radius motion. The resulting steering command is transmitted to a steer-by-wire actuator, enabling directional control of the vehicle to maintain or achieve the desired hitch angle during reverse maneuvers, thereby reducing driver workload and mitigating instability such as jackknifing.

One or more additional embodiments are directed to a computer program product that facilitates the movement of the trailer, the computer program product comprising readable storage medium having program instructions embodied therewith. The program instructions can be executable by a processor to cause the processor to configure a steer-by-wire component to receive steering wheel input and navigate the vehicle in reverse mode.

Also in another embodiment, the program instructions can be executable by a processor to cause the processor to estimate a hitch angle of a trailer coupled to the vehicle, and estimate an angular rate of the hitch angle through the data gathered from the hitch angle component; and to cause the processor to control the speed of the vehicle and front wheel steering angle input to maintain the hitch angle within a stable range.

Another embodiment may further cause the processor to use artificial intelligence that has been implicitly trained to facilitate the controller maintaining the hitch angle within the stable range along with the processor to use artificial intelligence that has been explicitly trained to facilitate the controller maintaining the hitch angle within the stable range.

In some embodiments, elements described in connection with the disclosed systems can be embodied in different forms such as a computer-implemented method, a computer program product, or another form.

### DESCRIPTION OF THE DRAWINGS

FIG. 1 illustrates a diagram of an example, non-limiting system that depicts a mechanical connection between the steering wheels and the road wheels and also depicts replacing this mechanical connection with an electrical connection in accordance with one or more embodiments described herein.

FIG. 2 illustrates a diagram of an example, non-limiting kinematic model based on a bicycle model for the vehicle based on geometry in accordance with one or more embodiments described herein.

FIG. 3 presents a set of graphs depicting an example, non-limiting evaluation of error between the linear and non-linear equation as presented in the kinematic model in accordance with one or more embodiments described herein.

FIG. 4 presents a flow diagram which illustrates an example, non-limiting process related to vehicle-trailer angle control in accordance with one or more embodiments described herein.

FIG. 5 presents a flow diagram which illustrates an example, non-limiting process related to demanded angular rate control in accordance with one or more embodiments described herein.

FIG. 6 is a flow chart showing how the torque on the steering wheel is defined which illustrates an example, non-limiting system in accordance with one or more embodiments described herein.

FIGS. 7A-7D illustrate various embodiments of innovations described herein.

FIG. 8 illustrates 8 an example, non-limiting basic feedback control loop block in accordance with one or more embodiments described herein.

FIG. 9 presents a set of images which depict an example, non-limiting simulation in accordance with one of more embodiments described herein.

FIG. 10 presents detailed graphical results of an example, non-limiting simulation in accordance with one of more embodiments described herein.

FIG. 11 depicts an example, non-limiting experimental vehicle with a prototype steer-by-wire system and a standard trailer in accordance with one or more embodiments described herein.

FIG. 12 presents detailed graphical results of an example, non-limiting test case in accordance with one of more embodiments described herein.

FIG. 13 illustrates a block diagram of an example, non-limiting operating environment in which one or more embodiments described herein can be facilitated.

FIG. 14 illustrates an example networking environment operable to execute various implementations described herein.

Appendix A is a paper that discloses various embodiments, and forms part of this specification.

Appendix B is a paper that discloses various embodiments, and forms part of this specification.

### DETAILED DESCRIPTION

The following detailed description is merely illustrative and is not intended to limit, claims, embodiments and/or application or uses of embodiments. Furthermore, there is no intention to be bound by any expressed or implied information presented in the preceding Summary section or in the Detailed Description section.

Embodiments disclosed herein introduce significant enhancements over prior implementations of trailer backup assist systems, particularly through integration of advanced control logic, self-calibrating trailer geometry, and intelligent user interaction mechanisms enabled by steer-by-wire technology. These improvements collectively transform a trailer reversal experience from a cognitively demanding and error-prone task into an intuitive, stable, and adaptable maneuver across diverse driving conditions and operator skill levels.

One or more embodiments make use of a proportional feedback controller that directly governs hitch angle (ϕ) between a vehicle and trailer. This control strategy departs from conventional approaches that merely adjust steering angle based on driver input, instead allowing a driver to directly command a desired hitch angle. A mathematically linearized kinematic model maps this hitch angle error into a desired angular rate (ϕ^{⋅}), which is then transformed into a precise steering angle command. This control framework ensures that a system remains dynamically stable even during complex reverse maneuvers, as confirmed by pole placement and eigenvalue analysis within a state-space control formulation. This improvement is especially significant for preventing destabilization and jackknifing, problems endemic to traditional trailer reversing.

A non-limiting novel aspect is introduction of a real-time trailer length estimation algorithm. Rather than relying on user-entered trailer geometry or embedded trailer electronics, the system passively observes vehicle speed, steering angle, and hitch articulation behavior during steady-state maneuvers to infer distance from a tow hitch to a trailer axle. This parameter, significant for accurate model-based control, is automatically estimated without requiring user calibration or predefined trailer profiles. Such autonomy not only improves usability but also supports dynamic trailer switching in fleet or rental environments. It is to be appreciated that in certain embodiments trailer length can be estimated while in motion.

One or more embodiment(s) also expand a human-machine interface through dual-mode steering wheel feedback: a “joystick mode” where wheel angle directly controls hitch angle rate, and a “torque mode” that generates force feedback proportional to the driver's deviation from a target angle. This bidirectional feedback, enabled by steer-by-wire architecture, intuitively guides the user toward stable reversal trajectories while preventing overcorrection. The addition of spring-damper-based torque modeling further enhances driver comfort and safety by softening rapid or erratic inputs.

Additionally, embodiment(s) are architected for deployment in both onboard and networked environments. By modularizing a processing unit, a system may operate using embedded microcontrollers, digital signal processors (DSPs), field-programmable gate arrays (FPGAs), or via cloud-based control infrastructure, enabling scalability across automotive platforms. The system further supports multiple sensor modalities (or sensor modules)—including inertial sensors, mechanical transducers, and vision-based detection, allowing robust operation across varying trailer types and configurations. It is to be appreciated that in various embodiments the terms sensor module and hitch angle determination module can be used interchangeably.

Collectively, these advancements substantially broaden the scope, applicability, and commercial value of trailer backup assist systems. Embodiment(s) thus reflect a significant technical leap in vehicle automation, control robustness, and driver-assist usability, while preserving backward compatibility with prior embodiments.

One or more embodiments described herein is directed to utilizing a steer-by-wire system in conjunction with a closed loop-trailer reversal control system to create a trailer back-up assist system. A trailer that is pulled behind a vehicle, commonly referred to as a towable trailer, is a non-motorized vehicle designed to be attached to and towed by a powered vehicle, such as a car, truck, or other vehicle. Trailers are used for a wide range of purposes, from recreational activities like camping to commercial uses such as transporting goods, equipment, and livestock. They offer flexibility and additional cargo capacity for vehicles, making them essential tools for both personal and professional use. Backing up a trailer can be a daunting task, even for experienced drivers. The main challenge being the non-minimum-phase property of vehicle-trailer kinematics resulting from off-axle interconnections. This property, together with the intrinsically unstable nature of reversal, makes reversing a trailer a task akin to the stabilization of an inverted pendulum. For example, to initiate a turn, the driver must first steer in the opposite direction of the turn. After the turn is initiated, the driver must stabilize the motion since the trailer angle constantly has the tendency to diverge from the desired angle.

Reversing a trailer using a vehicle is an unstable process. A small disturbance or an error can cause a big offset on the trailer direction, making it less intuitive for drivers to correct and maintain the trailer direction. The trailer back-up assist system described herein finds a way for drivers to control the direction of the trailer using a steer-by-wire system, where the steering wheel input directly controls the trailer-vehicle hitch angle instead of the rack position. The system shows robustness dealing with disturbances.

There are many benefits with the introduction of steer-by-wire into vehicles. There are both economic and functional reasons for this introduction, examples of economic reasons are such as fewer modifications for left- or right-hand drive vehicles, simpler axle geometry and weight and space reductions. The main functional reason for steer-by-wire is the possibility of having a steering ratio that changes with speed, surface, etc. Other functions can also be implemented with steer-by-wire, such as assisting the driver while driving in strong wind. In this case, the steer-by-wire will be used to assist the driver in reversing with a trailer.

Reversing with a trailer is known to be a difficult maneuver and a lot of experience is needed in order to be able to do so in a good and accurate way. The main problem lies in that the system is unstable, if you go straight back with the vehicle and trailer system, sooner or later the trailer will stop going straight back and will end up hitting the vehicle. It is also difficult since the direction that the trailer will go, will always be opposite to the direction the vehicle will go because they are linked with a ball joint.

The trailer back-up assist system described herein is different when compared to a traditional “non-steer-by wire” vehicle since it takes the input from the driver of what the desired vehicle-trailer angle should be instead of what the wheel angle should be. While this maneuver could also be achieved in a traditional vehicle without steer-by-wire, there are drawbacks.

In traditional “non-steer-by wire” systems, the steering wheel is mechanically connected with the steering rack. Because of this, controlling the trailer direction using the steering wheel is unrealistic as it would require an extra system, other than the steering wheel, in order to bypass the steering wheel for inputting the desired command to the steering rack. In a steer-by-wire system, the mapping between the steering wheel and the steering rack is programmable, which makes it possible to use the steering wheel as a controller for the vehicle-trailer hitch angle, while the steering rack outputs the required steering angle on the front wheels of the vehicle without mechanical constrictions. This reduces the parts needed for the structure and also reduces the possibility of malfunctions.

The primary challenge lies in the difficulty for the driver to translate their desired trailer movements through the steering wheel, which is mechanically linked to the wheels. Consequently, the steering wheel must constantly mirror the wheel angles, necessitating the use of alternative mechanisms, such as a knob, for the driver to specify the desired vehicle-trailer angle e.g., the ϕ angle. This setup results in the steering wheel rotating during maneuvers, sometimes at high speeds, causing discomfort for the driver and potentially posing safety risks.

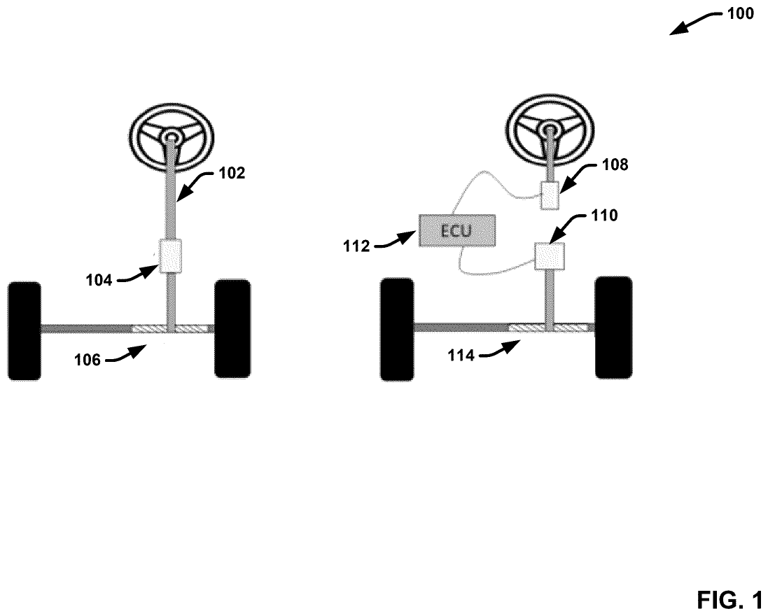

Turning to FIG. 1, depicted is a traditional “non-steer-by wire” system 100 where there is a mechanical connection between steering wheels and road wheels. At a high level this mechanical connection consists of a steering column 102, steering gear 104, and rack and pinion 106. In contrast, a steer-by wire system as depicted replaces the mechanical connection with an electrical connection. This means that the steering wheel input no longer has to be directly linked to the front wheel steering angle. In the case of trailer reversal, the driver would probably prefer to focus on maneuvering the trailer directly and not have to worry about the non-minimum phase property of the car-trailer kinematics and unstable motion during reversal. This decoupled control could be possible with a steer-by-wire system coupled with a closed-loop trailer reversal control.

A steer-by wire system consists of a driver feedback motor 108 which connects to Electric Control Unit (ECU) 112. The ECU is a computer that receives signals from the steering wheel and relays the signals to the steering rack. The ECU is additionally interfaced with Electric Power-Assisted Steering (EPAS) 110. In this embodiment the EPAS is a type of electric steering that employs an electric motor to assist a driver in turning the wheel. EPAS can help drivers maintain control when steering on uneven or twisting roads. It's become standard equipment in most new cars and trucks, replacing conventional hydraulic power steering systems. EPAS systems can include features like adjustable power assist, pre-wiring for easy installation, and a potentiometer to control the amount of assistance provided. The EPAS is then interfaced to the rack and pinion 114.

The objective of a trailer backup assist function is then to assist drivers in safely and effectively maneuvering a vehicle while towing a trailer. This is done by using a combination of steering wheel actuator, sensors, and software to make the process of backing up with a trailer easier for drivers.

An aspect of embodiments described herein is to develop and implement a system that is used for helping the driver reverse with a trailer. A further aspect of embodiments described herein design and implement a means to control the reversing trailer vehicle combination by utilizing steering wheel angle and torque of a steer by-wire-system and to illustrate a strategy to prevent exceeding the critical articulation angle for beyond which it is not possible to reduce the angle when reversing. With that, it is also required to understand what sensor data can be utilized, this could include computer vision.

Vehicle simulation tools such as IPG CarMaker and Matlab Simulink can be used in initial stages, while in later stages a real vehicle and trailer will be used. Experiments can be conducted to evaluate how much better performance of such a trailer back-up assist system would be compared to normal driving for both drivers with and without experience reversing with a trailer, this can be done in both simulations and in the real vehicle system.

A kinematic model can be used in this innovation. This model which will be used in the vehicle to make it possible to control the angle or angular rate between the trailer and the vehicle can be based on a geometric analysis. The model can be based on a bicycle model of a vehicle connected to a trailer.

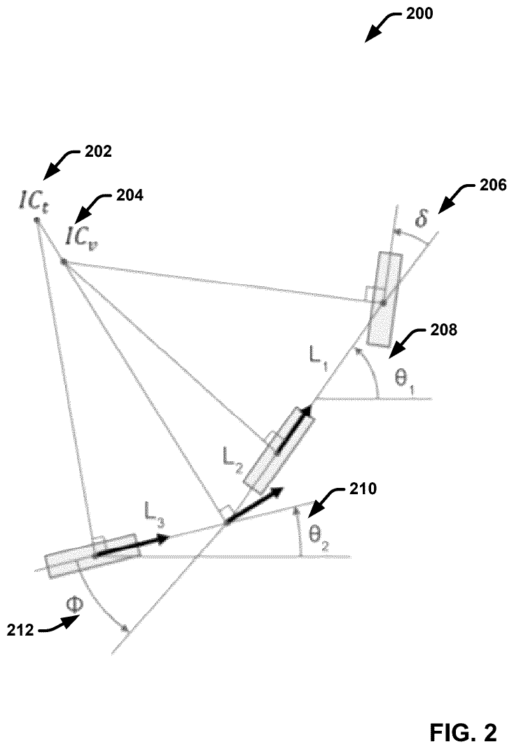

In FIG. 2 diagram 200 is observed, in this kinematic model there are both fixed variables such as the wheelbase (L1), length from the tow hook to the rear axle of the vehicle (L2) as well as the length from tow hook to the axle on the trailer (L3). Additionally, there are values that will change with time such as, actual and demanded vehicle-trailer angle ϕ 212, the actual and demanded angular rate ^{⋅}ϕ as well as the speed of the vehicle.

The trailer backup assist algorithm is based on the car-trailer kinematics behavior. The basic car-trailer geometry is shown in FIG. 2. The resulting equations of motion assume no slip (pure rolling), flat terrain, and a rigid hitch connection. Given that θ=ψₜ−ψᵥ we have the following equations of motion for the car and trailer, where v is the car's speed.

$${\dot{ψ}}_{v} = \frac{v}{{L}_{1}} tan ( δ ) , \qquad ( 1 A )$$

$${\dot{ψ}}_{t} = - \frac{{L}_{2} {\dot{ψ}}_{v} cos ( θ ) + v sin ( θ )}{{L}_{3}} , \qquad ( 2 A )$$

The angle between the vehicle and trailer ϕ 212 is defined as seen in Equation 1 where θ₁ 208 and θ₂ 210 are the vehicle and trailer global angle respectively. This can be observed in FIG. 2.

$$ϕ = {θ}_{2} - {θ}_{1} \qquad ( 1 )$$

The angular rate of the angle ϕ 212 is defined in Equation 2 as

$$\dot{ϕ} = {\dot{θ}}_{2} - {\dot{θ}}_{1} \qquad ( 2 )$$

The points ICₜ 202 and ICᵥ 204 are the trailer's and vehicle's rotational centers respectively. These are defined as the points around which the bodies rotate.

Based on the bicycle model in FIG. 2, equations can be derived on how the angular rate of the angle between the vehicle and trailer (^{⋅}ϕ) depends on the speed of the vehicle (v), the angle between the vehicle and trailer (ϕ) 212, and the steering angle (δ) 206. This can be seen in equation 3.

$$\dot{ϕ} = \frac{v \cdot sin ( - ϕ )}{{L}_{3}} - \frac{v}{{L}_{1}} \cdot ( 1 + \frac{{L}_{2} \cdot cos ( - ϕ )}{{L}_{3}} ) \cdot tan ( δ ) \qquad ( 3 )$$

Equation 3 is non-linear. The non-linearity is a problem for stability and robustness if it is to be controlled. This means that a linearization of the equation has to be done. There are multiple ways to linearize this system but a simple and effective method of doing it is to use a first-order Taylor expansion. This is a local linearization and the linearization will be done around zero for ϕ 212.

The first-order Taylor expansion gives the following equation:

$$\dot{ϕ} = - \frac{v}{{L}_{3}} \cdot ϕ - \frac{v}{{L}_{1}} \cdot ( 1 + \frac{{L}_{2}}{{L}_{3}} ) \cdot δ \qquad ( 4 )$$

If the equation is derived for δ (206), it gives:

$$δ = \frac{\dot{ϕ} + \frac{υ}{{L}_{3}} \cdot ϕ}{- \frac{υ}{{L}_{1}} \cdot ( 1 + \frac{{L}_{2}}{{L}_{3}} )} \qquad ( 5 )$$

It can be noted that the articulation angle decreases in magnitude when the car's instantaneous center of motion, ICᵥ, is inside that of the trailer, ICₜ, as is the case in FIG. 2. This means that in order to decrease the articulation angle, one has to steer more than required to keep a constant articulation angle constant (ICᵥ and ICₜ coincide). This is counter-intuitive to new drivers learning to reverse a trailer for the first time. That is, in order for the trailer to turn less, the car (initially) needs to turn more.

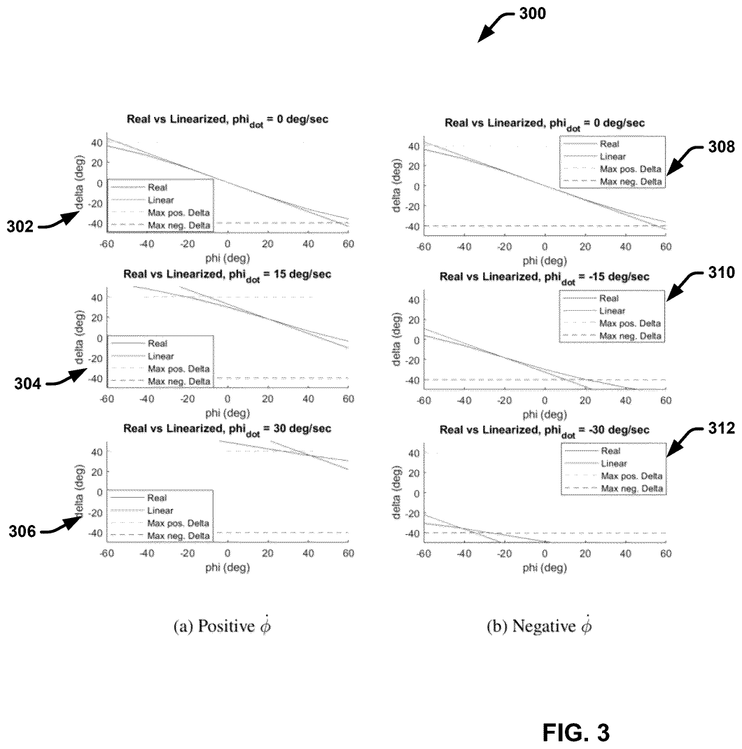

Next, we see in FIG. 3 an overview of how large the error is between the linear and non-linear equation in different regions.

The linearization gives good results for lower values of ^{⋅}ϕ but for higher values of ^{⋅}ϕ the results are quite far from the actual value. This can be seen in the graphs 302, 304, 306, 308, 310, and 312.

It can also be seen in FIG. 3 that the error of the linearization of the equation is not symmetric around ϕ=0. This means that the linear equation gives better estimations for large values of ^{⋅}ϕ if it has the same sign as ϕ. To ensure that the linear model gives accurate control values, emphasis should be laid on limiting ^{⋅}ϕ so that the real model and the linear model's values are sufficiently close as determined by how the system reacts to the input from the driver.

In practice, there is a real limit on the steering angle, the operating regions are limited as shown by dotted lines in the graphs 302, 304, 306, 308, 310, and 312 with steering angle between 40 degrees and −40 degrees. The higher the angular rate is, the narrower the operating region is. As demonstrated, the errors between the linear model and the real model are well under control.

In order to analyze the stability of the trailer back-up assist system, pole position analysis of the system is required. The stability with and without the trailer back-up assist system are examined by checking the eigenvalues of the state-space equations. Eigenvalues are the special set of scalar values associated with the set of linear equations. Eigenvalues are key to understanding the intrinsic properties of linear transformations represented by matrices. They reveal how matrices act on vectors, indicating directions of stretching, compressing, or reversing. Finding eigenvalues involves solving the characteristic polynomial, a fundamental task in linear algebra.

When examining the vehicle-trailer system without any back-up assist, the main equation is Equation 4. The eigenvalue of the system is in the form of

$$- \frac{v}{L 3} ,$$

which lies in the left-hand side of the complex plane if and only if v takes on a positive value, indicating forward driving. In this sense, the system is unstable when reversing. The analysis result matches what happens in reality since driving forward with a trailer is controllable and stable while reversing with a trailer is not. The instability of reversing raises the need for a trailer back-up assist system to ensure that the eigenvalue is in the left-hand side of the complex plane.

Jackknifing is an accident that occurs when a vehicle towing a trailer loses control of the trailer and it swings out to form an L or V shape. The name comes from the resemblance of the angled truck to a folding pocket knife. Jackknifing can more technically be described as the phenomenon when the angle between the vehicle and the trailer enters a region where the angle can no longer be decreased while reversing. For jackknifing to happen, two things have to occur, first the maximum steering angle on the vehicle has to be reached. Second, the angular rate has to be higher for the trailer than for the vehicle. This can be visualized by seeing that the distance to the instant center of rotation of the trailer, ICₜ 202, is shorter than it is for the vehicle, ICᵥ 204, and can be seen in FIG. 2.

Based on Equation 4 and Equation 5, a decision on whether to control ϕ or ^{⋅}ϕ can be made and corresponding control loops can be designed and tuned. Equation 5 serves as the steering angle block that connects the control loop with the steering rack on the vehicle. Control loop designs will be shown and explained based on the value to control. No matter what driving mode is going to be implemented on the vehicle, it is either controlling ϕ or ^{⋅}ϕ of the trailer back-up assist system.

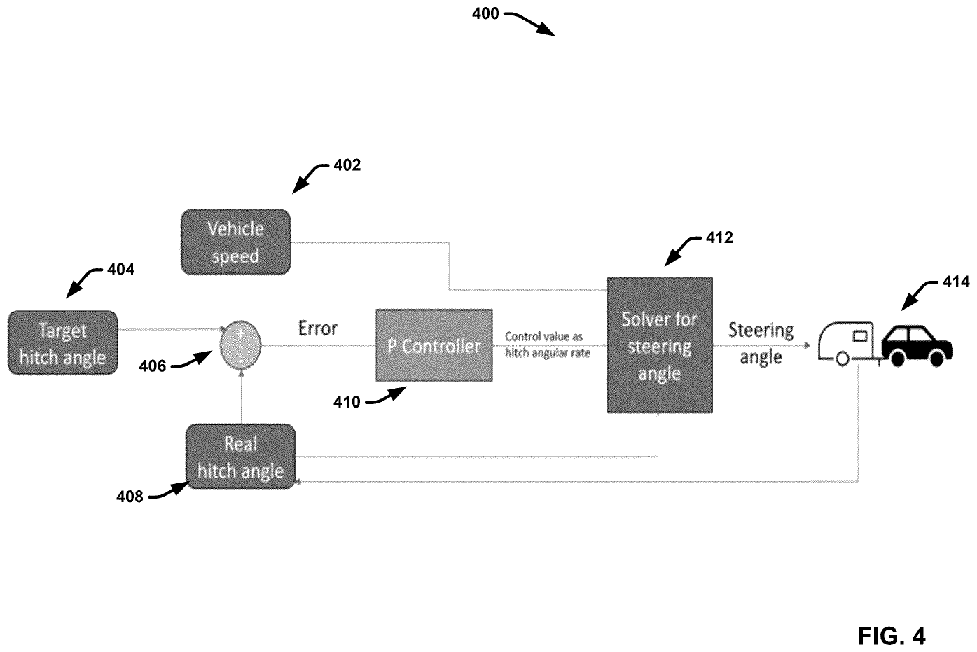

In FIG. 4, a flowchart is presented which illustrates a process related to the decision to control ϕ. When controlling ϕ, a control value seen in Equation 6 should replace ^{⋅}ϕ in Equation 5 since this is the first-order derivative of time of ϕ. The control value is based on difference between real-time ϕ 408 and target ϕ 404, this can be seen as the error value 406. The error value is fed to a P controller (P controller and Controller shall be used interchangeably) 410 which output ^{⋅}ϕ is the input to the steering angle block 412. Vehicle speed 402 is also input into the steering angle block 412. The output of this block is a steering angle that should be on the front wheels of vehicle 414.

In order to perform stability analysis, a control value in Equation 6 needs to replace ^{⋅}ϕ in Equation 5 as shown in Equation 7 where k is the kₚ for the P controller 410.

$${\dot{ϕ}}_{target} = k \cdot ( {ϕ}_{target} - ϕ ) \qquad ( 6 )$$

$${δ}_{target} = \frac{{\dot{ϕ}}_{target} + \frac{υ}{{L}_{3}} \cdot ϕ}{- \frac{υ}{{L}_{1}} \cdot ( 1 + \frac{{L}_{2}}{{L}_{3}} )} \qquad ( 7 )$$

$$\dot{ϕ} = - \frac{υ}{{L}_{3}} \cdot ϕ - \frac{υ}{{L}_{1}} \cdot ( 1 + \frac{{L}_{2}}{{L}_{3}} ) \cdot {δ}_{target} \qquad ( 8 )$$

Equation 8 is generated by applying Equation 7 to Equation 4, after which the eigenvalue of the system is changed to (−k). When the vehicle-trailer system is reversing, v is a negative value. To ensure the stability of reversing, k needs to be larger than 0 so that the eigenvalue lies in the left-hand side of the complex plane.

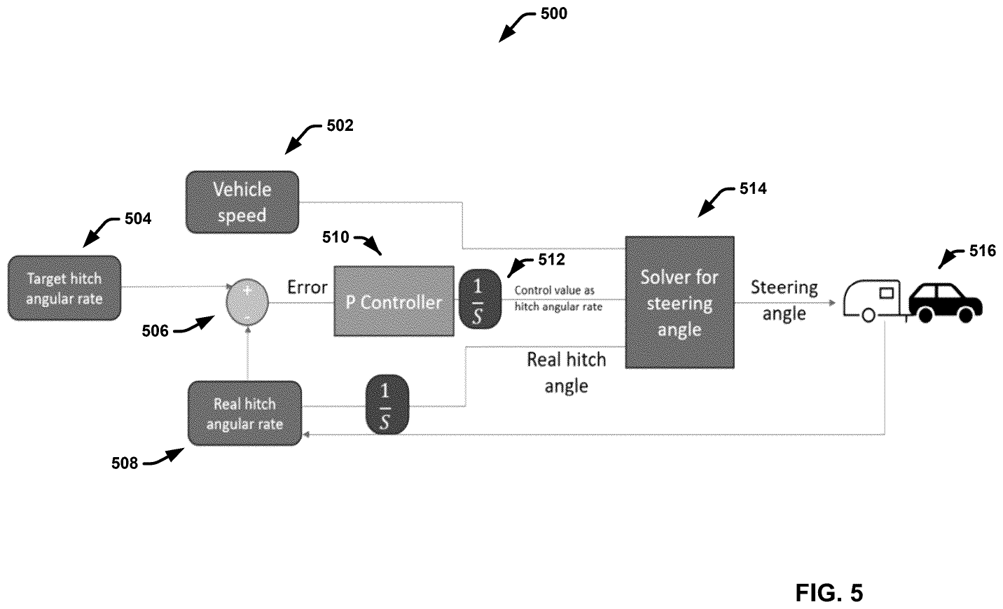

Next, we turn to examining FIG. 5, in which a flowchart is presented illustrating the process related to the decision to control ^{⋅}ϕ. For controlling ^{⋅}ϕ, the control value from a P controller 510 that is based on the error ^{⋅}ϕ 506 between the target 504 and the real-time value 508 should represent ^{⋅⋅}ϕ. To use the Equation 5, the control value needs to be integrated over time 1/S 512. The stability condition is the same as before, when controlling ϕ, with a k larger than 0 then the system is stable, since the eigenvalue lies in the left-hand side of the complex plane. Vehicle speed 502 is also input into the steering angle block 514. The output of this block is a steering angle that should be on the front wheels of vehicle 516.

As demonstrated the length of the trailer to its wheel axle (L₃) is a needed input for the model described thus far. If the length estimation of the trailer is done manually by the driver, this is a cumbersome process. The length of the trailer is not always known and it can be difficult to accurately measure the length. Therefore, it would be beneficial if there was a way for the vehicle to determine the length of the trailer on its own accurately. This could be done using an error prediction method, using the parameter value that minimizes the quadratic sum of the prediction errors. But to make the system compact and more efficient, another simple yet effective way of determining the length of the trailer is created and utilized. This is by using Equation 3 to derive the length of the trailer L₃. The equation for L₃ can be seen in Equation 9.

$${L}_{3} = - \frac{υ \cdot ( sin ( ϕ ) \cdot {L}_{1} + {L}_{2} \cdot cos ( ϕ ) \cdot tan ( δ ) )}{\dot{ϕ} \cdot {L}_{1} + υ \cdot tan ( δ )} \qquad ( 9 )$$

This equation, Equation 9, will provide length of the trailer whenever all variables in the equation are stable. The system automatically starts length estimation the moment the driver drives the vehicle forward after the trailer is connected to the vehicle for the first time. The vehicle-hitch angle as well as its angular rate, steering angle, and vehicle speed will be recorded during a short period when there is a stable set of inputs from the driver and the distance between the trailer axle and the tow hook can be calculated using Equation 9.

The easiest way to get stable inputs is to start the length estimation while going forward in a circle with a fixed steering angle. This means that ^{⋅}ϕ and ϕ will move towards a steady value. This will make the equation easier to solve as well as make the result more stable. If the trailer gets replaced by a different trailer, the system will work again to estimate the new geometry. In theory, the estimation also works during reversing if the trailer assist system is not active. After the automatic length estimation, the result will be sent to the controller as input of trailer length. The driver could also choose to manually input the length through the GUI in the car.

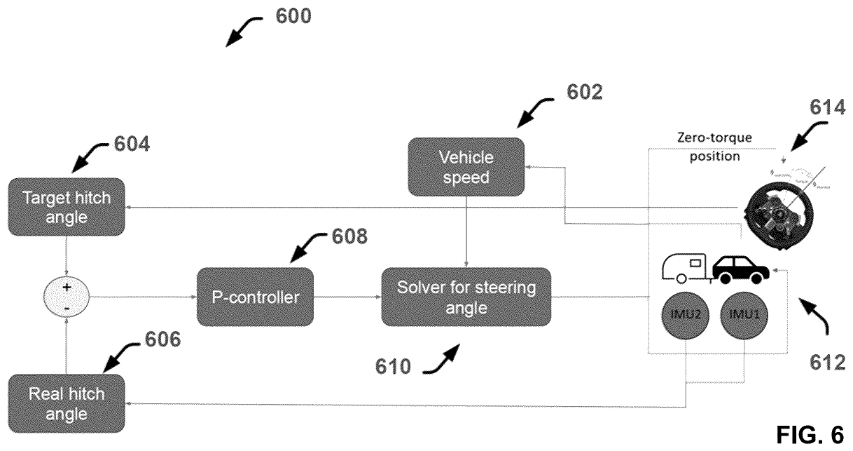

FIG. 6 is a flow chart showing how torque on the steering wheel is defined, the control value from a P controller 608 that receives an input of the error between the target 604 and the real-time value 606. Vehicle speed 602 is also input into the steering angle block 610. The output of this block is a steering angle that should be on the front wheels of vehicle 612. The angle between the car and trailer can be determined in different ways, we developed two ways of doing it. Firstly, we used two IMUs 612, one in the car and one in the trailer, then we integrated their yaw rate over time to get their respective yaw angle, and from that we can get the car-trailer angle. The zero-torque position of the steering wheel 614 always follows the real-time car-trailer angle.

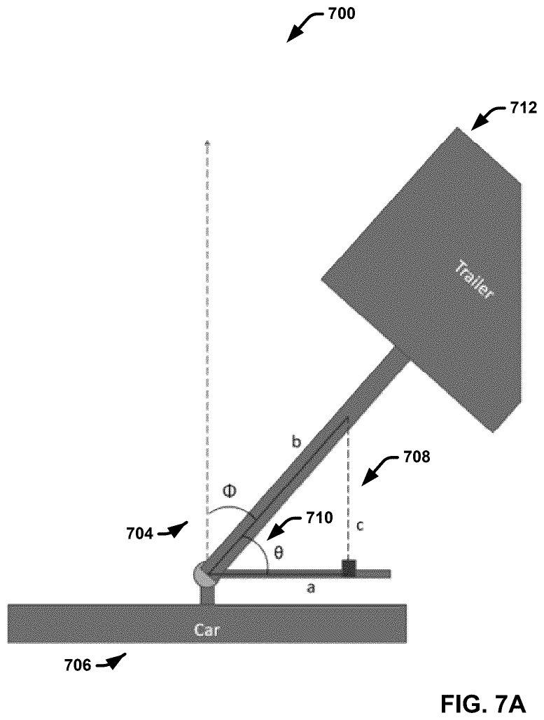

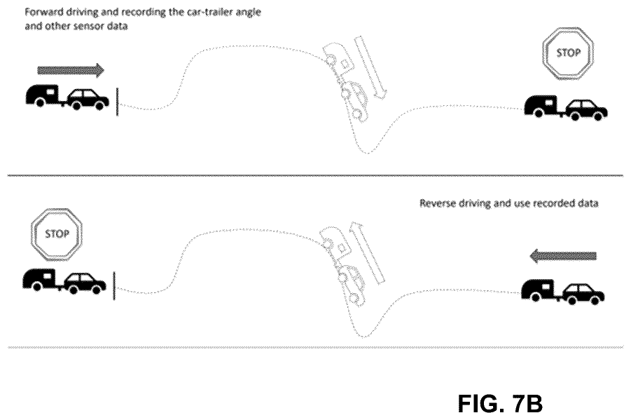

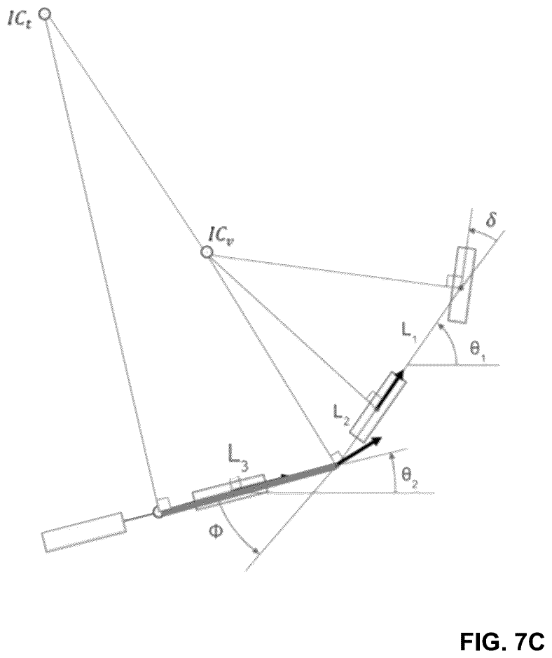

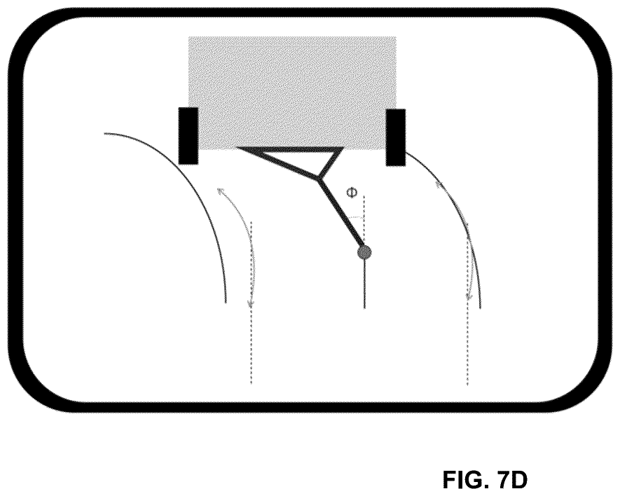

The car-trailer angle can also be determined using a linear transducer, based on the length of the rope of the linear transducer and the geometry of the system as can be seen in the FIG. 7A.

In the trailer back-up assist system, detecting the angle between the vehicle and the trailer is a key intermediate procedure. Based on such information, the controller can command the steering system to keep or change the vehicle-trailer angle based on control mode and user input. A mechanical measurement and an inertial measurement of determining the angle will be considered, but this could also be done with computer vision.

FIG. 7A illustrates a diagram related to an example, non-limiting geometric angle calculation using a linear transducer in accordance with one or more embodiments described herein. 706 and 712 refer to the car and trailer respectively. Mechanical angle estimation can be performed using a linear transducer. The linear transducer determines ϕ 704 by calculating angles 710 within a triangle that is structured as shown in FIG. 7A. Since a linear transducer often has a very high accuracy down to an error of (±0.25%) this means that this method of estimating the angle can be very accurate.

The law of cosine provides:

$$θ = arc cos ( \frac{{a}^{2} + {b}^{2} - {c}^{2}}{2 \cdot a \cdot b} ) \qquad ( 10 )$$

The basic law of sum gives:

$$ϕ = \vert θ - \frac{π}{2} \vert \qquad ( 11 )$$

In this case, a is the lateral length of the rod to the connection point of the linear transducer (SP1-12), b is the length from the hitch hook to the connection point on the trailer and c 708 is the length of the extended wire of the linear transducer. These lengths can be seen in FIG. 7A. Since the wire on the linear transducer is of a certain length, it is also important to make sure that the wire will not break during any maneuver due to the wire being too short.

In another embodiment as depicted in FIG. 7B, relates to recorded maneuver where the vehicle can record and store data on maneuver, both sensor data but also data on angles between the vehicle and trailer over time. This would make it possible for the vehicle to reverse the trailer into any spot that vehicle car has driven out from. Instead of recording the path, the hitch angle shall be recorded to guide the reverse process since the dynamics for forward and reverse driving with a trailer is different. Furthermore, it will be difficult for the car to end up in the exact same spot as the end position when driving forward, an AI or a human in the loop might be needed to help the car to get into that position to begin the reverse with as well as correcting errors during the reverse process. This could be very popular for drivers who need to park a trailer from time to time to a fixed parking area. This system could also upload stored data to a cloud which would make it possible for other vehicles to use the same path to get into the required path.

Another embodiment as illustrated in FIG. 7C, related to multi-axle vehicle potential. This system is not only viable for passenger cars, it can easily be used on a truck as well but then L3 means the distance between the tow hook and the average axle center position on the trailer.

Yet another embodiment as depicted in FIG. 7D, relates to warning and feedback on the user interface. The system can be assisted with a warning & feedback interface so that the driver gets more information when using it. For example, when the road condition is complicated such as being very inclined or very slippery, the system will inform the driver of the potential danger detected by itself. Also, the system warns the driver of nearby obstacles and shut the progress when needed. The user interface shows information on the central screen or with the Heads-up Display (HUD).

Another embodiment relates to remote driver. This system could also be used in cases where autonomous driven vehicles drive with a trailer and get stuck in some way. Then a person in a remote place could take over the steering of the autonomous car and help the autonomous car get out of the tricky situation. This system could also use external cameras from the nearby area to help the remote driver to reverse the trailer in a safe way.

An embodiment relates to rear-wheel turning on the car. To make the system more reactive and more agile, the car can be further equipped with a rear-wheel turning function. The geometry on the car part (expression for its yaw rate) will be slightly changed but the system should work in theory.

An embodiment relates to zero torque positioning. A steering wheel orientation is linearly related to hitch angle such that in a zero position, the vehicle and trailer are directly aligned in parallel. Thus, steering angle and hitch angle are at a zero position, as the steering wheel angle is changed the hitch angle is changed in linear proportion. For example, if the steering wheel angle is at 45 degrees, the hitch angle is likewise 45 degrees. If the steering wheel angle is 90 degrees, the hitch angle is 90 degrees relative to the vehicle. With such embodiment, the driver has greater certainty as to orientation of the trailer relative to vehicle and thus able to effect precise controlled positioning of the trailer. It is to be appreciated that non-linear relationships that can affect accurate control of trailer position via the steering wheel are contemplated and can be employed in connection with various embodiments.

This could be useful for truck/semi-truck drivers to get into the required position for the loading bay, since the vehicle usually uses the same path of travel to get into the area.

A further embodiment relates to an approach that does not use the desired rate of change of the articulation angle as the target as has been described thus far but rather calculates the required road wheel angle to maintain the desired articulation angle constant. The road wheel angle required to maintain a constant articulation angle is not speed dependent. The key to this is that the current steering angle needs to be proportional to the difference of the steering angles required to maintain the current articulation angle and the target articulation angle. If the proportionality constant is larger than one, the steering angle follows automatically. This proportionality constant can be speed dependent.

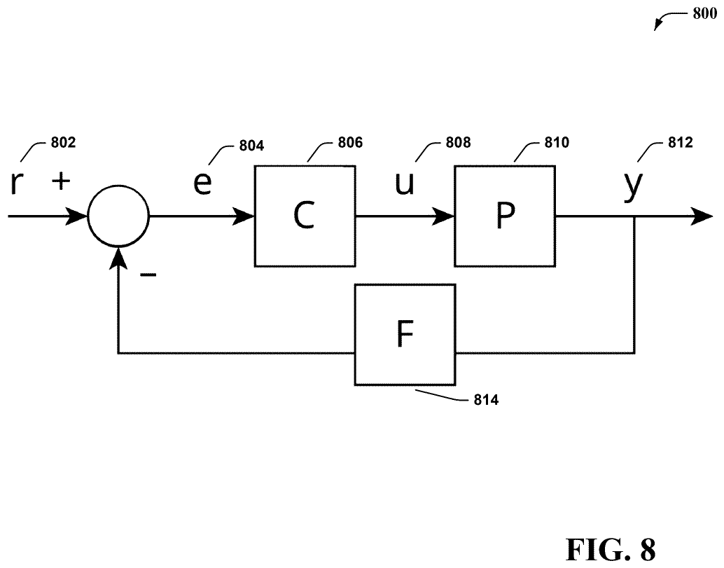

FIG. 8 is a basic feedback control loop block. A basic feedback control loop block diagram consists of interconnected blocks representing different components of a control system including a controller, process, sensor, and feedback path. The diagram illustrates how the system adjusts its output based on the difference between the desired output and the actual output as measured by the sensor. This closed-loop system automatically corrects itself to reduce error over time.

The trailer backup assist system in this work is based on a generic feedback control as shown in FIG. 8 where 802 (r) is the reference input (desired) value, 812 (y) is the process (actual output) value. The control input 808 (u) is then based on the difference between the reference and process values, this is also called the manipulated variable. Other components of the diagram include 804 (e), the actuating signal, also called the error signal, which represents the control action of the control loop. The control elements 806 also called the controller are the components needed to generate the appropriate control signal to be applied. The disturbance 810 is an undesirable input signal that upsets the controlled output 812. The feedback elements 814, are the components needed to identify the functional relationship between the feedback signal and the controlled output 812.

In order to determine the road wheel angle required to achieve the desired articulation angle, the following steps are taken. First, measure or estimate the current car-trailer articulation angle, θ_{y}. Second, determine the steering angle, δ_{y}, required to maintain the current articulation angle (process value). Third, determine the desired articulation angle, θᵣ, based on the steering wheel input. Fourth, determine the reference road wheel angle δᵣ required to maintain the desired articulation angle (reference value). Fifth, control the road wheel angle, δᵤ, based on the control error δᵣ−δ_{y}.

The desired articulation angle θr is set to be directly proportional to the steering wheel angle δ_{SW} such that the maximum steering wheel angle will yield the maximum possible articulation angle (with some safety margin to jackknifing). The required steering angle to maintain a constant actual (y) or desired (r) articulation angle can be found from Equation 3 with θ^{⋅}=0 such that

$$tan ( δ ) = - \frac{{L}_{1} sin ( θ )}{{L}_{2} cos ( θ ) + {L}_{3}} , \qquad ( 12 )$$

θ is either the current articulation angle θ_{y} or the target articulation angle θᵣ. In this work, feedforward based on the target road wheel angle and simple proportional feedback are used to obtain the required steering input such that

$${δ}_{u} = - {δ}_{r} + {k}_{p} ( {δ}_{r} - {δ}_{y} ) . \qquad 13 )$$

Jackknifing is when the car-trailer angle can no longer be reduced but increases until there is contact between the car and trailer. This so-called critical angle is reached the moment the car and the trailer share the same yaw rate and the front wheels are steered to their maximum value. To find the critical hitch angle, calculations can be done to find when the car and trailer share the same instant center of rotation when the maximum geometrical angle on the front wheels is reached. An estimate of the critical angle θ^{⋅}_{crit} can be found from Equation 4 when θ^{⋅}=0 and δ=δₘₐₓ such that

$${θ}_{crit} = - \frac{{L}_{3}}{{L}_{1}} \cdot ( 1 + \frac{{L}_{2}}{{L}_{3}} ) \cdot tan ( {δ}_{m ax} ) ; \qquad 14 )$$

This means that to prevent jackknifing from occurring, θ should not be allowed to pass the critical angle. The width of the car and trailer is not considered in this calculation, which might lead to the critical angle not being reached before the car and trailer hit each other if the car or the trailer is very wide.

A series of simulations to evaluate the performance and reliability of the trailer backup assist function were conducted. These simulations were designed to replicate a variety of steering angle inputs. The results provided valuable insights into the system's responsiveness, accuracy, and overall effectiveness in aiding drivers during reversing maneuvers. One of these simulations was to study the response to a step input in the steering wheel angle input from the driver—which resulted in a corresponding step in the required articulation angle.

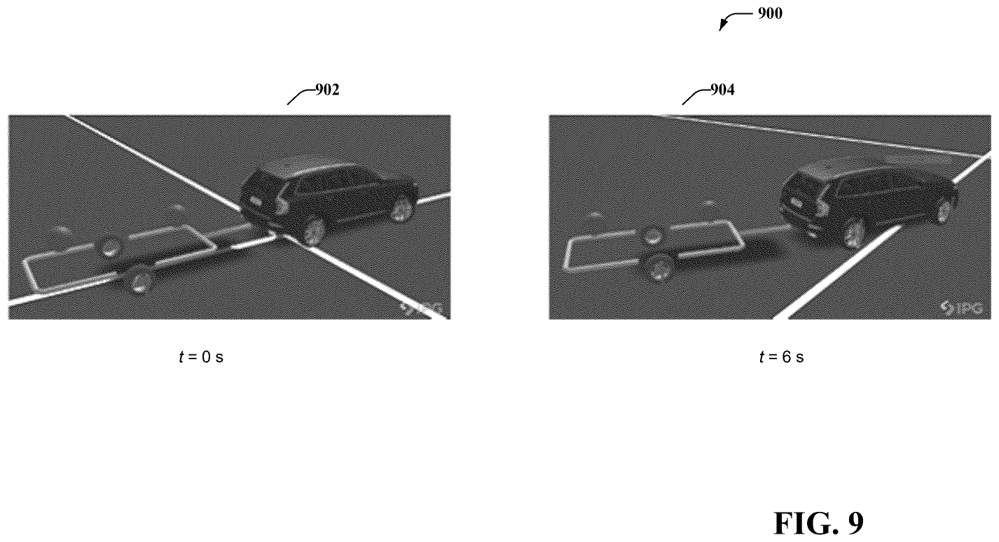

In the simulation results shown in FIG. 9, a counter-clockwise (left) steering wheel angle input translated to a required articulation angle of 15 degrees 902. As can be seen from 902, at time equals zero seconds, the steering angle demand to the left translates to an initial road wheel angle to the right. This is what is expected when reversing with a trailer, but highlights that this is a capability only possible with steer-by-wire; the road wheel angle is completely out of phase with the steering angle input. After a transition phase, 904 at time equals six seconds, the desired articulation angle is reached and the road wheel angle is again in phase with the steering wheel angle input.

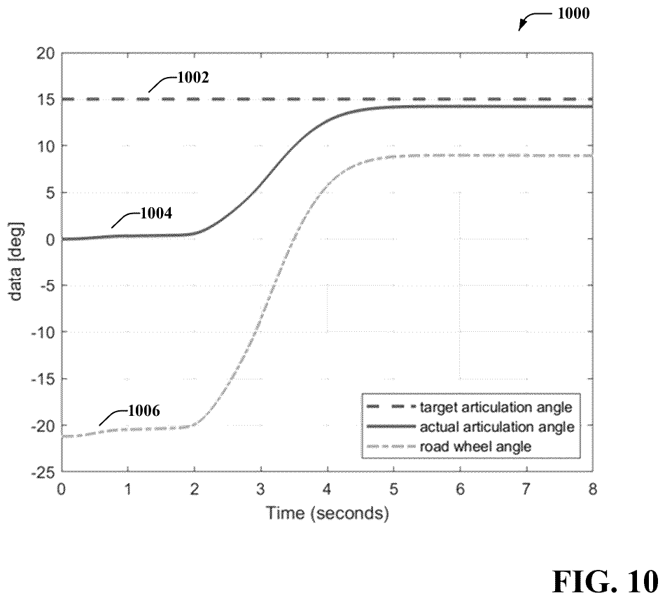

More detailed results of this simulation can be seen in FIG. 10. The target articulation angle 1002 refers to the desired angle between the vehicle and trailer. The actual articulation angle 1004 is the real, measured angle between the vehicle and trailer at a given moment. The road wheel angle 1006 refers to the angle of the vehicle's wheels relative to the vehicle's longitudinal axis (i.e., the direction the vehicle is pointing), specifically in the context of steering.

It is notable that the actual trailer angle 1004 never quite reaches the desired steering angle 1002. This is because there is proportional control, in practice the driver can compensate for this error with some additional steering demand.

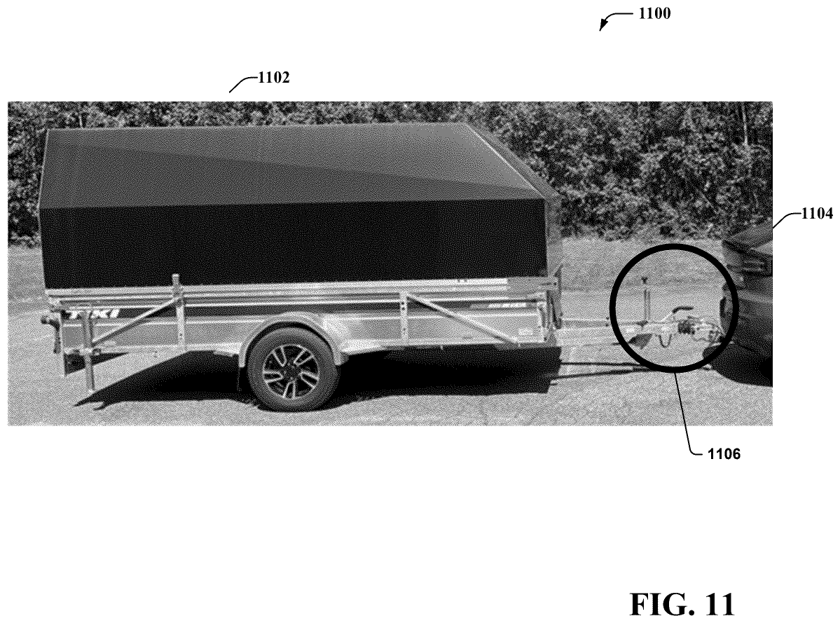

In FIG. 11 an experimental vehicle 1104 with a prototype steer-by-wire system and a standard trailer 1102 is shown. This means that the front wheel angle can be controlled independently from the steering wheel input. An additional yaw rate sensor can be seen on the tow bar as encompassed by the circle 1106.

In this prototype vehicle, the articulation angle is estimated using two identical internal measurement units. One is mounted on the vehicle 1104, and the other is mounted on the trailer 1102. The articulation angle is then determined by time integration of the difference in yaw rate of each unit. In order to compensate for sensor bias, the averaged yaw rate difference (moving average) at standstill is subtracted from the yaw rate difference that is measured when the car is moving. Additionally, a manual reset of the yaw angle to zero has been implemented.

The trailer backup function is implemented as described above and such that the road wheel angle demand is decoupled from the steering wheel input when the gear is in reverse and the trailer backup assist is activated. Instead, the road wheel angle is determined by Equation 13.

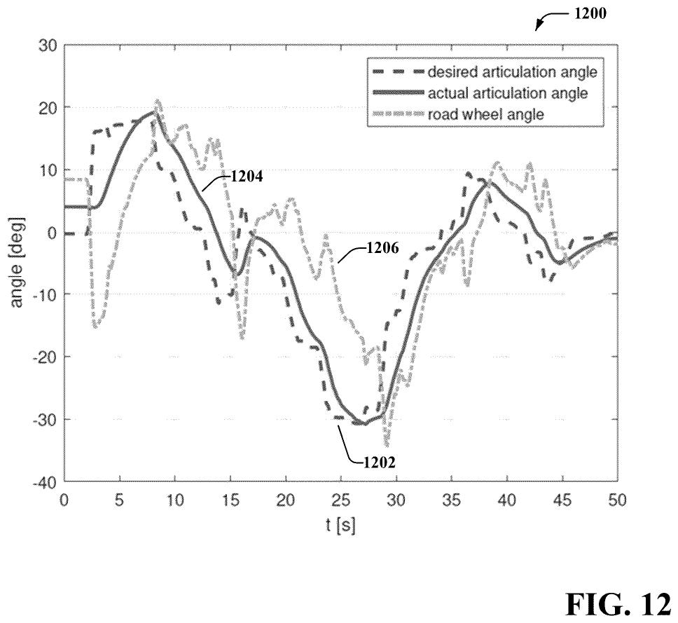

Preliminary results are shown in FIG. 12. From these results, it can be clearly seen that for every change in articulation angle demand, which is directly proportional to the steering wheel angle input, the actual articulation angle 1204 is initially out of phase with the steering angle demand 1206, but eventually transitions to an in-phase steering as the articulation angle changes to the desired articulation angle 1202.

The experiments were conducted with a constant speed of approximately 5 km/h, and it can be clearly seen from the results that there is a significant delay between the demanded articulation angle 1206 and the actual articulation angle 1204. This is because the car-trailer combination needs to move a certain distance until the desired articulation can be reached. This is due to the fact the articulation angle cannot be controlled directly, but only indirectly as a result of a series of road wheel angle inputs 1206 and car-trailer motion. From the experimental results, it can be clearly seen that there is much less input required from the driver compared 1204 to what otherwise would be the case 1206. This goes to highlight one of the main benefits of the function.

The performance of the simple trailer backup assist algorithm was verified with simulations and experiments with a steer-by-wire prototype. The function has one input, the desired articulation angle, which is directly proportional to the steering wheel angle and only requires measurement or estimation of the actual articulation angle as feedback. The function's nonlimiting accomplishments include steering the trailer in the direction of the steering wheel input and stabilizing the articulation angle to the target value.

This means that if the driver wants the articulation angle to be zero, the driver simply keeps the steering angle input zero. If the driver wants to steer the trailer to the left, the steering wheel needs to be steered to the left. If the driver wants to increase the articulation angle, the driver steers more while driving backwards. This is in contrast to how trailer reversing is done without the trailer backup function. In this case, the driver has to steer in the opposite direction of the trailer to change the articulation angle (steer more to decrease and less to increase) and additionally needs to constantly compensate for the tendency of the articulation angle to diverge if the steering angle is held constant.

In the prototype vehicle, the articulation angle is estimated with an additional yaw rate sensor, but this is one non-limiting possibility. The articulation angle can be estimated using the rearward camera(s), possibly combined with the ultrasonic proximity sensors used to aid parking or other technologies. This implies that no additional sensor would be required for the estimation of the articulation angle.

The experiments found that moving the trailer required much less steering wheel inputs from the driver, but did require some adaptation to work well. Although several of the test drivers were well acquainted with backing up a trailer without any backup assist, the much-reduced steering wheel input meant that focus could be shifted from the required steering wheel angle input to maneuvering the trailer.

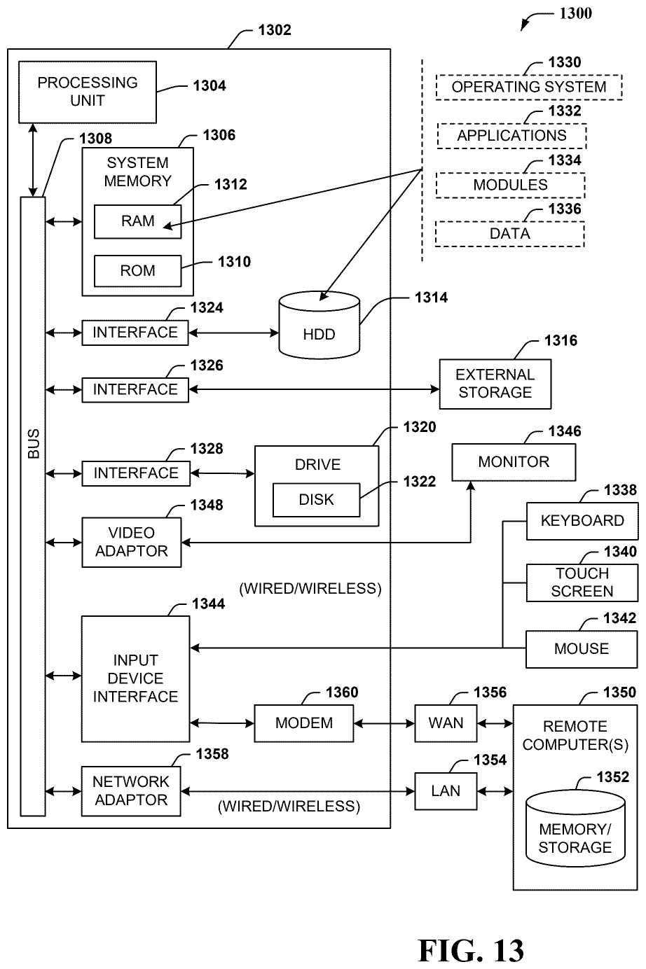

With reference to FIG. 13, an example environment 1300 for implementing various embodiments of the aspects described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1308 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), one or more external storage devices 1316 (e.g., a magnetic floppy disk drive (FDD) 1316, a memory stick or flash drive reader, a memory card reader, etc.) and a drive 1320, e.g., such as a solid state drive, an optical disk drive, which can read or write from a disk 1322, such as a CD-ROM disc, a DVD, a BD, etc. Alternatively, where a solid state drive is involved, disk 1322 would not be included, unless separate. While the internal HDD 1314 is illustrated as located within the computer 1302, the internal HDD 1314 can also be configured for external use in a suitable chassis (not shown). Additionally, while not shown in environment 1300, a solid state drive (SSD) could be used in addition to, or in place of, an HDD 1314. The HDD 1314, external storage device(s) 1316 and drive 1320 can be connected to the system bus 1308 by an HDD interface 1324, an external storage interface 1326 and a drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enable with a security module, such as a trusted processing module (TPM). For instance, with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

The computer 1302 can operate in a networked environment using logical connections via wireless communications based GPRS, GSM, 5G, LTE, 6G protocols.

When used in a LAN networking environment, the computer 1302 can be connected to the local network 1354 through a wired or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are an example and other means of establishing a communications link between the computers can be used.

When used in either a LAN or WAN networking environment, the computer 1302 can access cloud storage systems or other network-based storage systems in addition to, or in place of, external storage devices 1316 as described above, such as but not limited to a network virtual machine providing one or more aspects of storage or processing of information. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

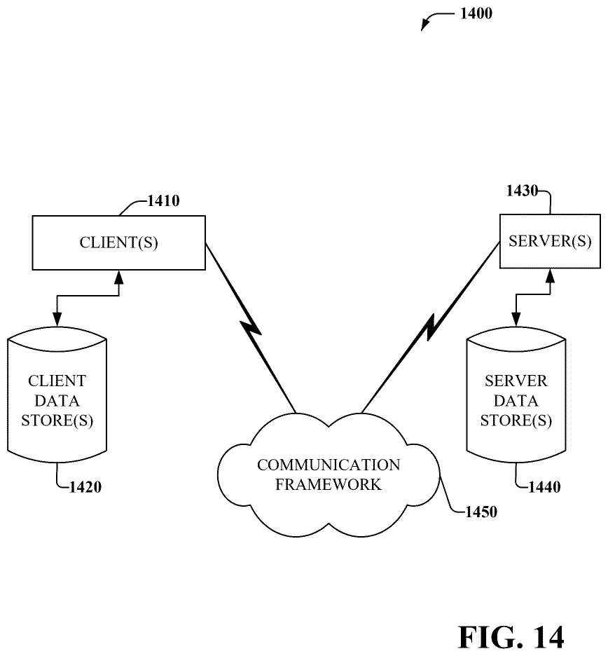

FIG. 14 is a schematic block diagram of a sample computing environment 1400 with which the disclosed subject matter can interact. The sample computing environment 1400 includes one or more client(s) 1410. The client(s) 1410 can be hardware or software (e.g., threads, processes, computing devices). The sample computing environment 1400 also includes one or more server(s) 1430. The server(s) 1430 can also be hardware or software (e.g., threads, processes, computing devices). The servers 1430 can house threads to perform transformations by employing one or more embodiments as described herein, for example. One possible communication between a client 1410 and a server 1430 can be in the form of a data packet adapted to be transmitted between two or more computer processes. The sample computing environment 1400 includes a communication framework 1450 that can be employed to facilitate communications between the client(s) 1410 and the server(s) 1430. The client(s) 1410 are operably connected to one or more client data store(s) 1420 that can be employed to store information local to the client(s) 1410. Similarly, the server(s) 1430 are operably connected to one or more server data store(s) 1440 that can be employed to store information local to the servers 1430.

The present invention may be a system, a method, an apparatus or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above includes mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

One or more embodiments of the present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Various aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing one or more embodiments, but one of ordinary skill in the art can recognize that many further combinations and permutations of these embodiments are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The terminology used herein was chosen to best explain the principles of the embodiments, the practical application or technical improvement over technologies found in the marketplace, or to enable others of ordinary skill in the art to understand the embodiments disclosed herein. In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various non-limiting aspects of various embodiments described herein are presented in the following clauses.

1. A vehicle maneuvering system, comprising a processor and a memory communicatively coupled to the processor, the memory having stored therein computer-executable instructions, comprising a steer-by-wire component configured to receive steering wheel input and navigate the vehicle in reverse mode and a hitch angle component that estimates hitch angle of a trailer coupled to the vehicle, and estimates angular rate of the hitch angle through the data gathered from the hitch angle component and a controller that controls speed of the vehicle and the front wheel steering angle input to maintain the hitch angle within a stable range.

2. The system of any preceding clause, wherein the controller facilitates maintaining a zero-torque relationship with the steering wheel angle and hitch angle.

3. The system of any preceding clause, wherein artificial intelligence has been implicitly trained to facilitate the controller maintaining the hitch angle within the stable range.

4. The system of any preceding clause, wherein artificial intelligence has been explicitly trained to facilitate the controller maintaining the hitch angle within the stable range.

5. The system of any preceding clause, wherein the controller estimates the steering angle of the vehicle using the following equation:

$$δ = \frac{\dot{ϕ} + \frac{υ}{{L}_{3}} \cdot ϕ}{- \frac{υ}{{L}_{1}} \cdot ( 1 + \frac{{L}_{2}}{{L}_{3}} )}$$

wherein:
L₁ is wheelbase of the vehicle;
L₂ is length from a tow hook to rear axle of the vehicle;
L₃ is length from the tow hook to axle on the trailer;
V is velocity of the vehicle; and
Φ is angle between the vehicle and the trailer.

6. The system of any preceding clause, wherein the controller maintains the hitch angle to below a threshold that can result in jack knifing of the trailer.

7. The system of any preceding clause, wherein the controller estimates the length of the trailer (L₃) using the following equation:

$${L}_{3} = - \frac{υ \cdot ( sin ( ϕ ) \cdot {L}_{1} + {L}_{2} \cdot cos ( ϕ ) \cdot tan ( δ ) )}{\dot{ϕ} \cdot {L}_{1} + υ \cdot tan ( δ )} .$$

8. The system of any preceding clause, wherein a linear transducer is used to estimate Φ, angle between the vehicle and the trailer.

9. The system of any preceding clause, wherein a set of yaw sensors facilitate estimating Φ, the angle between the vehicle and the trailer, wherein the controller integrates difference between vehicle and trailer yaw angular rate (θdot₁ and θdot₂) over time.

In various cases, any suitable combination or combinations of clauses 1-9 can be implemented.

10. A computer implemented method, comprising configuring by the system to receive steering wheel input and navigate the vehicle in reverse mode and estimating by the system a hitch angle of a trailer coupled to the vehicle, and estimating by the system an angular rate of the hitch angle through the data gathered from the hitch angle component and controlling by the system, the speed of the vehicle and front wheel steering angle input to maintain the hitch angle within a stable range.

11. A computer implemented method of any preceding clause, wherein the controller facilitates maintaining a zero-torque relationship with the steering wheel angle and hitch angle.

12. A computer implemented method of any preceding clause, further comprising implementing by the system, artificial intelligence that has been implicitly trained to facilitate the controller maintaining the hitch angle within the stable range.

13. A computer implemented method of any preceding clause, further comprising implementing by the system, artificial intelligence that has been explicitly trained to facilitate the controller maintaining the hitch angle within the stable range.

14. A computer implemented method of any preceding clause, further comprising estimating by the system, the steering angle of the vehicle using the following equation:

$$δ = \frac{\dot{ϕ} + \frac{υ}{{L}_{3}} \cdot ϕ}{- \frac{υ}{{L}_{1}} \cdot ( 1 + \frac{{L}_{2}}{{L}_{3}} )}$$

wherein:
L₁ is wheelbase of the vehicle;
L₂ is length from a tow hook to rear axle of the vehicle;
L₃ is length from the tow hook to axle on the trailer;
V is velocity of the vehicle; and
Φ is angle between the vehicle and the trailer.

15. A computer implemented method of any preceding clause, further comprising maintaining by the system the hitch angle to below a threshold that can result in jack knifing of the trailer.

16. A computer implemented method of any preceding clause, further comprising estimating by the system the length of the trailer (L₃) using the following equation:

$${L}_{3} = - \frac{υ \cdot ( sin ( ϕ ) \cdot {L}_{1} + {L}_{2} \cdot cos ( ϕ ) \cdot tan ( δ ) )}{\dot{ϕ} \cdot {L}_{1} + υ \cdot tan ( δ )}$$

17. A computer implemented method of any preceding clause, further comprising estimating by the system Φ, the angle between the vehicle and the trailer using a linear transducer.

18. A computer implemented method of any preceding clause, further comprising estimating by the system Φ using a set of yaw sensors, the angle between the vehicle and the trailer, wherein the controller integrates difference between vehicle and trailer yaw angular rate (θ^{dot}₁ and θ^{dot}₂) over time.

In various cases, any suitable combination or combinations of clauses 11-18 can be implemented.

19. A computer program product for a vehicle maneuvering system, the computer program product from any preceding clause comprising a non-transitory computer readable storage medium having program instructions embodied therewith, the program instructions executable by a processor on board to cause the processor to configure steer by wire to receive steering wheel input and navigate the vehicle in reverse mode and estimate the hitch angle of a trailer coupled to the vehicle, and estimate the angular rate of the hitch through the data gathered from the hitch angle component and control the speed of the vehicle and front wheel steering angle input to maintain the hitch angle within a stable range.

20. A computer program product for a vehicle maneuvering system, the computer program product from any preceding clause comprising a non-transitory computer readable storage medium having program instructions embodied therewith, the program instructions executable by a processor on board to cause the processor to implement artificial intelligence that has been implicitly trained to facilitate the controller maintaining the hitch angle within the stable range.

21. A computer program product for a vehicle maneuvering system, the computer program product from any preceding clause comprising a non-transitory computer readable storage medium having program instructions embodied therewith, the program instructions executable by a processor on board to cause the processor to implement artificial intelligence that has been explicitly trained to facilitate the controller maintaining the hitch angle within the stable range.

22. A computer program product for a vehicle maneuvering system, the computer program product from any preceding clause comprising a non-transitory computer readable storage medium having program instructions embodied therewith, the program instructions executable by a processor on board to cause the processor to estimate the steering angle of the vehicle using the following equation:

$$δ = \frac{\dot{ϕ} + \frac{υ}{{L}_{3}} \cdot ϕ}{- \frac{υ}{{L}_{1}} \cdot ( 1 + \frac{{L}_{2}}{{L}_{3}} )}$$

wherein:
L₁ is wheelbase of the vehicle;
L₂ is length from a tow hook to rear axle of the vehicle;
L₃ is length from the tow hook to axle on the trailer;
V is velocity of the vehicle; and
Φ is angle between the vehicle and the trailer.

In various cases, any suitable combination or combinations of clauses 19-24 can be implemented. 23. A computer program product for a vehicle maneuvering system, the computer program product from any preceding clause comprising a non-transitory computer readable storage medium having program instructions embodied therewith, the program instructs are further executable by the processor to cause the processor to: maintain the hitch angle to below a threshold that can result in jack knifing of the trailer.

24. A computer program product for a vehicle maneuvering system, the computer program product from any preceding clause comprising a non-transitory computer readable storage medium having program instructions embodied therewith, the program instructs are further executable by the processor to cause the processor to:

Estimate the length of the trailer (L₃) using the following equation:

$${L}_{3} = - \frac{υ \cdot ( sin ( ϕ ) \cdot {L}_{1} + {L}_{2} \cdot cos ( ϕ ) \cdot tan ( δ ) )}{\dot{ϕ} \cdot {L}_{1} + υ \cdot tan ( δ )} .$$

In various cases, any suitable combination or combinations of clauses 19-24 can be implemented.

25. A trailer backup assist system for a vehicle comprising: a steer-by-wire component configured to receive steering wheel input; a hitch angle determination module configured to detect an angular relationship ϕ between the vehicle and a trailer coupled to the vehicle; a control system comprising a proportional controller that generates a target angular rate ϕ^{⋅} based on a difference between a target hitch angle ϕₜ and the detected angular relationship ϕ, such that ϕ^{⋅}=k(ϕₜ−ϕ), where k is a positive gain value; a trailer length estimation component configured to automatically estimate a distance L₃ between a tow hitch and an axle of the trailer using steering angle, vehicle velocity, and ϕ, wherein the distance is calculated using a steady-state form of a nonlinear trailer kinematics equation; and a processing unit configured to execute instructions that convert ϕ^{⋅} to a steering angle command for the steer-by-wire system using a linearized control model.

26. The system of any preceding clause, wherein the linearized kinematic model is based on a first-order Taylor expansion of a nonlinear car-trailer model centered at ϕ=0.

27. The system of any preceding clause, wherein the proportional gain k is selected such that an eigenvalue of a closed-loop state-space system lies in the left-hand side of the complex plane.

28. The system of any preceding clause, wherein the system further limits the maximum value of ϕ^{⋅} based on steering constraints or jackknife thresholds.

29. The system of any preceding clause, further comprising a torque feedback system for a steer-by-wire steering wheel, configured to: (a) in a joystick mode, apply resistive torque urging the wheel toward a neutral position corresponding to ϕ^{⋅}=0; or (b) in a torque mode, apply spring-damper-based torque in proportion to a difference between ϕₜ and ϕ.

30. The system of any preceding clause, wherein the torque is computed using a virtual spring constant and a damping constant tuned for safe trailer reversal.

31. The system of any preceding clause, wherein a zero-torque steering position is dynamically aligned with a current hitch angle ϕ.

32. The system of any preceding clause, wherein the hitch angle determination module comprises at least one of: (a) a linear transducer mechanically mounted between the vehicle and trailer; (b) a pair of yaw sensors mounted on the vehicle and trailer, respectively; or (c) an image processing module configured to determine ϕ using visual markers on the trailer.

33. The system of any preceding clause, wherein the image processing module detects a chessboard marker and determines ϕ using a minimum rectangle detection method with Hough transforms.

34. The system of any preceding clause, wherein yaw sensor drift is corrected by subtracting a measured drift rate when the vehicle is stationary.

35. The system of any preceding clause, wherein the trailer length estimation is performed during forward driving with a fixed steering angle to reach a steady-state ϕ^{⋅} and ϕ.

36. The system of any preceding clause, wherein the system records multiple measurements of ϕ^{⋅}, ϕ, vehicle velocity, and steering angle to derive L₃ using an inverse of the kinematic equation.

37. The system of any preceding clause, wherein the trailer length L₃ is re-estimated each time a new trailer is attached.

38. The system of any preceding clause, further comprising a jackknife prevention module configured to calculate a critical angle beyond which the trailer angular rate exceeds that of the vehicle.

39. The system of any preceding clause, wherein the critical angle is determined based on the relative lengths of the car and trailer rotational radii.

40. The system of any preceding clause, wherein the system prevents ϕ from exceeding the critical angle by limiting driver input or by modifying k adaptively.

41. A computer-implemented method for assisting trailer reversal using a steer-by-wire vehicle system, comprising: receiving, by a sensor module, a hitch angle ϕ between a vehicle and a trailer coupled to the vehicle; receiving, via a user input device, a desired hitch angle ϕₜ representing a target angular relationship between the vehicle and the trailer; computing, by a controller, a target hitch angular rate ϕ^{⋅} according to a proportional control law defined by: ϕ^{⋅}=k(ϕₜ−ϕ), where k is a positive gain value; computing a steering command based on a linearized kinematic model that maps ϕ^{⋅}, vehicle speed, and trailer length L₃ to a front wheel steering angle; estimating the trailer length L₃ from measured vehicle speed, hitch angle ϕ, hitch angular rate ϕ^{⋅}, and front wheel steering angle; outputting the steering command to a steer-by-wire actuator for directional control of the vehicle during trailer reversal.

42. The method of any preceding clause, wherein determining the hitch angle ϕ comprises fusing signals from a linear transducer and a pair of inertial measurement units (IMUs) mounted on the vehicle and the trailer, respectively.

43 The method of any preceding clause, further comprising applying a dynamic torque to a steer-by-wire steering wheel based on: (a) a spring-like term proportional to (ϕₜ−ϕ), and (b) a damper-like term proportional to the rate of steering wheel rotation, such that the torque provides haptic feedback guiding the user toward the desired trailer orientation.

44. A non-transitory computer-readable medium storing instructions that, when executed by a processor, cause a vehicle control system to: determine a hitch angle ϕ between a vehicle and a trailer; determine a trailer length L₃ using a model-based estimation from steering angle, vehicle velocity, and the hitch angle; generate a target hitch angular rate ϕ^{⋅}=k(ϕₜ−ϕ) using a proportional controller; compute a steering angle δ using a linearized kinematic model; and output a steering command to a steer-by-wire actuator of the vehicle.

45. In various cases, any suitable combination of clauses 25-40 can be implemented.

46. In various cases, any suitable combination of clauses 41-43 can be implemented.

45. In various cases, any suitable combination of clauses 1-44 can be implemented.

What is claimed is:

1. A trailer backup assist system for a vehicle comprising:
a steer-by-wire component configured to receive steering wheel input;
a hitch angle determination module configured to detect an angular relationship ϕ between the vehicle and a trailer coupled to the vehicle;
a control system comprising a proportional controller that generates a target angular rate ϕ^{⋅} based on a difference between a target hitch angle ϕₜ and the detected angular relationship ϕ, such that ϕ^{⋅}=k(ϕₜ−ϕ), where k is a positive gain value;
a trailer length estimation component configured to estimate a distance L₃ between a tow hitch and an axle of the trailer using steering angle, vehicle velocity, and ϕ, wherein the distance is calculated using a steady-state form of a nonlinear trailer kinematics equation; and
a processing unit configured to execute instructions that convert ϕ^{⋅} to a steering angle command for the steer-by-wire system using a linearized control model.

2. The system of claim 1, wherein the linearized kinematic model is based on a first-order Taylor expansion of a nonlinear car-trailer model centered at ϕ=0.

3. The system of claim 1, wherein the proportional gain k is selected such that an eigenvalue of a closed-loop state-space system lies in the left-hand side of the complex plane.

4. The system of claim 1, wherein the system further limits the maximum value of ϕ^{⋅} based on steering constraints or jackknife thresholds.

5. The system of claim 1, further comprising a torque feedback system for a steer-by-wire steering wheel, configured to:
(a) in a joystick mode, apply resistive torque urging the wheel toward a neutral position corresponding to ϕ^{⋅}=0; or
(b) in a torque mode, apply spring-damper-based torque in proportion to a difference between ϕₜ and ϕ.

6. The system of claim 5, wherein the torque is computed using a virtual spring constant and a damping constant tuned for safe trailer reversal.

7. The system of claim 5, wherein a zero-torque steering position is dynamically aligned with a current hitch angle ϕ.

8. The system of claim 1, wherein the hitch angle determination module comprises at least one of:
(a) a linear transducer mechanically mounted between the vehicle and trailer;
(b) a pair of yaw sensors mounted on the vehicle and trailer, respectively; or
(c) an image processing module configured to determine ϕ using visual markers on the trailer.

9. The system of claim 8, wherein the image processing module detects a chessboard marker and determines ϕ using a minimum rectangle detection method with Hough transforms.

10. The system of claim 8, wherein yaw sensor drift is corrected by subtracting a measured drift rate when the vehicle is stationary.

11. The system of claim 1, wherein the trailer length estimation is performed during forward driving with a fixed steering angle to reach a steady-state ϕ^{⋅} and ϕ.

12. The system of claim 1, wherein the system records multiple measurements of ϕ^{⋅}, ϕ, vehicle velocity, and steering angle to derive L₃ using an inverse of the kinematic equation.

13. The system of claim 1, wherein the trailer length L₃ is re-estimated each time a new trailer is attached.

14. The system of claim 1, further comprising a jackknife prevention module configured to calculate a critical angle beyond which the trailer angular rate exceeds that of the vehicle.

15. The system of claim 14, wherein the critical angle is determined based on the relative lengths of the car and trailer rotational radii.

16. The system of claim 14, wherein the system prevents ϕ from exceeding the critical angle by limiting driver input or by modifying k adaptively.

17. A computer-implemented method for assisting trailer reversal using a steer-by-wire vehicle system, comprising:
receiving, by a sensor module, a hitch angle ϕ between a vehicle and a trailer coupled to the vehicle;
receiving, via a user input device, a desired hitch angle ϕₜ representing a target angular relationship between the vehicle and the trailer;
computing, by a controller, a target hitch angular rate ϕ^{⋅} according to a proportional control law defined by:
ϕ^{⋅}=k(ϕₜ−ϕ), where k is a positive gain value;
computing a steering command based on a linearized kinematic model that maps ϕ^{⋅}, vehicle speed, and trailer length L₃ to a front wheel steering angle;
estimating the trailer length L₃ from measured vehicle speed, hitch angle ϕ, hitch angular rate ϕ^{⋅}, and front wheel steering angle;
outputting the steering command to a steer-by-wire actuator for directional control of the vehicle during trailer reversal.

18. The method of claim 17, wherein determining the hitch angle ϕ comprises fusing signals from a linear transducer and a pair of inertial measurement units (IMUs) mounted on the vehicle and the trailer, respectively.

19. The method of claim 18, further comprising applying a dynamic torque to a steer-by-wire steering wheel based on:
(a) a spring-like term proportional to (ϕₜ−ϕ), and
(b) a damper-like term proportional to the rate of steering wheel rotation, such that the torque provides haptic feedback guiding the user toward the desired trailer orientation.

20. A non-transitory computer-readable medium storing instructions that, when executed by a processor, cause a vehicle control system to:
determine a hitch angle ϕ between a vehicle and a trailer;
determine a trailer length L₃ using a model-based estimation from steering angle, vehicle velocity, and the hitch angle;
generate a target hitch angular rate ϕ^{⋅}=k(ϕₜ−ϕ) using a proportional controller;
compute a steering angle δ using a linearized kinematic model; and
output a steering command to a steer-by-wire actuator of the vehicle.
